(19) United States
(12) Patent Application Publication
(10) Pub. No.: US 2009/0219374 A1
(43) Pub. Date: Sep. 3, 2009

(54) INKJET RECORDING MATERIAL AND METHOD OF MANUFACTURING THE SAME

(75) Inventor: Hideki KAIMOTO, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/391,811

(22) Filed: Feb. 24, 2009

(30) Foreign Application Priority Data
Feb. 28, 2008 (JP) 2008-048263

(51) Int. Cl. B41J 3/407

(52) U.S. Cl. 347/106

(57) ABSTRACT

An inkjet recording material includes: a waterproof substrate; and at least two ink-receiving layers that are provided on the waterproof substrate and include a first ink-receiving layer and a second ink-receiving layer, wherein the second ink-receiving layer is located at a position nearer to the waterproof substrate than that of the first ink-receiving layer, the first ink-receiving layer comprises a pigment, a water-soluble zirconium compound, and a binder, the second ink-receiving layer comprises a pigment, a binder, and a water-soluble aluminum compound, the amount of the water-soluble aluminum compound being larger than that of a water-soluble aluminum compound included in the first ink-receiving layer, and at least 80% by mass of the binders included in the at least two ink-receiving layers comprises a polyvinyl alcohol having a saponification degree of 95% or higher. A method of manufacturing the inkjet recording material is also provided.

### CROSS-REFERENCE TO RELATED APPLICATION

This application claims priority under 35 USC 119 from Japanese Patent Application No. 2008-048263, the disclosure of which is incorporated by reference herein.

### BACKGROUND OF THE INVENTION

1. Field of the Invention

The present invention relates to an inkjet recording material and a manufacturing method thereof.

2. Description of the Related Art

A recording material that includes a substrate, such as paper, and a porous ink-receiving layer which is provided on the substrate and includes a pigment, such as amorphous silica, and a binder, such as polyvinyl alcohol, is known as a recording material used in an inkjet recording system.

In recent years, techniques of using zirconium compounds, aluminum compounds, or the like in inkjet recording materials have been studied. For instance, an inkjet recording material containing a water-soluble zirconium compound in an ink-receiving layer provided at a distance from a substrate and a water-soluble aluminum compound that is distributed more densely in a portion nearer the substrate, for the purpose of enhancing waterproofing and preventing bleeding and/or bronzing from occurring in highly humid surroundings, is known (see, for example, Japanese Patent Application Laid-Open (JP-A) No. 2006-110771).

Further, techniques of using polyvinyl alcohols having various degrees of saponification, as the binder used in an ink-receiving layer are known (see, for example, JP-A No. 2003-11498 and JP-A No. 2000-280600).

However, particularly when images are recorded by an inkjet recording method using a water-based dye ink, there are cases where recorded images undergo changes in hue with the elapse of time. In addition, it has been discovered that, when recorded images, particularly in a state of incomplete dryness, are partially overlaid with a substance such as another recording material, there are cases where hue differences develop between the recorded images in the overlaid portion and those in the non-overlaid portion (namely, overlap marks are formed).

### SUMMARY OF THE INVENTION

According to an aspect of the invention, an inkjet recording material is provided in which not only is bronzing prevented but hue changes and/or generation of overlap marks are also prevented. According to another aspect of the invention, a method of manufacturing the inkjet recording material is provided.

As a result of intensive research, it has been found that hue changes and/or generation of overlap marks can be prevented by using polyvinyl alcohol having a high saponification degree in a system that includes a water-soluble zirconium compound in an upper layer (a layer further from a substrate) and a water-soluble aluminum compound in a greater amount in a lower layer (a layer at a side nearer the substrate) than in the upper layer.

According to an aspect of the invention, an inkjet recording material includes:

a waterproof substrate; and

at least two ink-receiving layers that are provided on the waterproof substrate and include a first ink-receiving layer and a second ink-receiving layer,

wherein the second ink-receiving layer is located at a position nearer to the waterproof substrate than the first ink-receiving layer,

the first ink-receiving layer includes a pigment, a water-soluble zirconium compound, and a binder,

the second ink-receiving layer includes a pigment, a binder, and a water-soluble aluminum compound, the amount of the water-soluble aluminum compound being larger than that of a water-soluble aluminum compound included in the first ink-receiving layer, and

at least 80% by mass of the binders included in the at least two ink-receiving layers includes a polyvinyl alcohol having a saponification degree of 95% or higher.

According to another aspect of the invention, a method for manufacturing an inkjet recording material includes:

applying coating solution B including a binder, a pigment, and a water-soluble aluminum compound and a coating solution A including a binder, a pigment, and a water-soluble zirconium compound on a waterproof substrate such that the coating solution B and the coating solution A are applied on the waterproof substrate in this order,

wherein the amount of the water-soluble aluminum compound included in the coating solution B is larger than that of a water-soluble aluminum compound included in the coating solution A, and

wherein at least 80% by mass of the binders included in the coating solutions A and B for forming ink-receiving layers includes a polyvinyl alcohol having a saponification degree of 95% or more.

### DETAILED DESCRIPTION OF THE INVENTION

Inkjet Recording Material

An inkjet recording material according to an exemplary embodiment of the invention includes: a waterproof substrate; and at least two ink-receiving layers that are provided on the waterproof substrate and include a first ink-receiving layer and a second ink-receiving layer. The second ink-receiving layer is located at a position nearer to the waterproof substrate than the first ink-receiving layer. The first ink-receiving layer includes a pigment, a water-soluble zirconium compound, and a binder. The second ink-receiving layer includes a pigment, a binder, and a water-soluble aluminum compound, the amount of the water-soluble aluminum compound being larger than that of a water-soluble aluminum compound included in the first ink-receiving layer. In the inkjet recording material, at least 80% by mass of the binders included in the at least two ink-receiving layers includes a polyvinyl alcohol having a saponification degree of 95% or higher.

In such an inkjet recording material having the above-described constitution, not only bronzing is prevented but also hue changes and/or generation of overlap marks are prevented. In addition, bleeding in highly humid environments may also be prevented, and waterproofness may be enhanced.

In the exemplary embodiment of the invention, at least 80% by mass of the sum total (total amount) of the binders included in the ink receiving layers including the first layer and the second layer (hereinafter referred simply to as “all of the ink-receiving layers” or “the ink-receiving layer as a whole”) is a polyvinyl alcohol having a saponification degree of 95% or higher.

When the proportion of the polyvinyl alcohol having a saponification degree of 95% or higher is smaller than 80% by mass of the sum total of binders in all of the ink-receiving layers, hue changes and overlap mark conditions may be adversely affected.

The proportion of the polyvinyl alcohol having a saponification degree of 95% or higher is preferably 85% by mass or more, more preferably 90% by mass or more, particularly preferably 95% by mass or more, of the sum total of the binders included in all of the ink-receiving layers.

Preferred exemplary embodiments of the binders in the ink-receiving layers are described below from the viewpoints of further preventing hue changes and more effectively preventing film cracking in the ink-receiving layers.

A binder included in the first ink-receiving layer preferably includes a polyvinyl alcohol having a polymerization degree of 2,000 or lower, preferably 1,900 or lower, and particularly preferably 1,800 or lower.

A binder included in the second ink-receiving layer preferably includes a polyvinyl alcohol having a polymerization degree of 2,000 or higher, preferably 3,000 or higher, and particularly preferably 4,000 or higher.

Of those, the combination of the binders is preferably such a combination that a polyvinyl alcohol having a polymerization degree of 2,000 or lower is included as a binder included in the first ink-receiving layer and a polyvinyl alcohol having a polymerization degree of 2,000 or higher is included as a binder included in the second ink-receiving layer,

more preferably such a combination that a polyvinyl alcohol having a polymerization degree of 1,900 or lower is included as a binder included in the first ink-receiving layer and a polyvinyl alcohol having a polymerization degree of 3,000 or higher is included as a binder included in the second ink-receiving layer, and

particularly preferably such a combination that a polyvinyl alcohol having a polymerization degree of 1,800 or lower is included as a binder included in the first ink-receiving layer and a polyvinyl alcohol having a polymerization degree of 4,000 or higher is included as a binder included in the second ink-receiving layer.

Ink-Receiving Layer

The inkjet recording material according to the exemplary embodiment has at least two ink-receiving layers provided on a waterproof substrate.

The at least two ink-receiving layers include at least a first layer including a pigment, a water-soluble zirconium compound and a binder, and a second layer containing a pigment, a binder and a water-soluble aluminum compound. The second ink-receiving layer includes the water-soluble aluminum compound in a larger amount than that of a water-soluble aluminum compound included in the first ink-receiving layer.

In exemplary embodiments, in addition to the first ink-receiving layer and the second ink-receiving layer, the inkjet recording material may have another layer including an uppermost layer (e.g., a colloidal silica layer), an intermediate layer, or an undercoat layer, as required.

First Ink-Receiving Layer

The first ink-receiving layer (hereinafter may also be referred to as the “first layer”) includes a pigment, a water-soluble zirconium compound and a binder, and may further include other ingredients as required.

From the viewpoint of color developability, the first ink-receiving layer is preferably a layer that is located at a distance from a substrate, and is more preferably the uppermost layer that is most distant from the substrate.

Additionally, the first layer may have either a single-layer structure or a multi-layer structure including two or more layers.

Herein, the method of forming the first ink-receiving layer including a water-soluble zirconium compound is not particularly limited. For instance, it is possible to adopt a method of forming the first layer by use of a coating solution containing a water-soluble zirconium compound (e.g., coating solution A as described below), a method in which the upper side of the first layer (the first layer surface located at a side farthest from the substrate) is coated with an aqueous solution containing a water-soluble zirconium compound, a combination of these methods, or the like.

The first layer may or may not include a water-soluble aluminum compound. When the first layer includes a water-soluble aluminum compound, the amount of the water-soluble aluminum compound included in the first layer is smaller than the amount of a water-soluble aluminum compound included in the second layer. When the amount of a water-soluble aluminum compound included in the first layer is larger than that the amount included in the second layer, bronzing may be aggravated.

More specifically, the ratio of the mass of a water-soluble aluminum compound contained in the first layer to the mass of a water-soluble aluminum compound contained in the second layer (mass of water-soluble aluminum compound in first layer/mass of water-soluble aluminum compound in second layer), is from 0 to less than 1.0, preferably from 0 to less than 0.5, more preferably from 0 to less than 0.3, and particularly preferably 0 (in other words, it is optimal for the first layer to be free of water-soluble aluminum compounds).

There is no particular limitation to the amount of a water-soluble zirconium compound included in the first layer. However, the amount of the water-soluble zirconium compound with respect to the mass of the pigment in the first layer is preferably in a range of from 0.5 to 15 mass %, more preferably in a range of from 1 to 10 mass %, and particularly preferably in a range of from 4 to 10 mass %.

The thickness of the first layer is not particularly limited, but the thinner the better from the viewpoint of more fruitfully achieving the effects of the invention. More specifically, the dry coating amount of the first layer is preferably 8 g/m² or less, and more preferably in a range of from 1 to 7 g/m².

Second Ink-Receiving Layer

The second ink-receiving layer (hereinafter may also be referred to as “second layer”) according to the exemplary embodiment of the invention is a layer provided between a waterproof substrate and the first layer and at a position nearer the waterproof substrate than that of the first layer.

The second layer includes a pigment, a binder and a water-soluble aluminum compound. The amount of the water-soluble aluminum compound contained in the second layer is larger than that of a water-soluble aluminum compound included in the first layer. The second layer may further include another ingredient as required.

Additionally, the second layer may have either a single-layer structure or a multi-layer structure including two or more layers.

Moreover, the second layer may or may not include a water-soluble zirconium compound.

The amount of a water-soluble aluminum compound included in the second layer is not particularly limited, but is preferably in a range of from 0.5 to 15% by mass, and more preferably in a range of from 1 to 10% by mass, with respect to the mass of the pigment included in the second layer.

The thickness of the second layer is not particularly limited, but the thicker the better from the viewpoint of ensuring a sufficient ink-absorbing speed and ink-absorbing capacity. More specifically, the dry coating amount of the second layer is preferably 12 g/m² or more, and more preferably 15 g/m² or more.

Distributions of Water-Soluble Zirconium Compound and Water-Soluble Aluminum Compound

Next, a preferred exemplary embodiment of the distribution of a water-soluble aluminum compound in the thickness direction of the ink-receiving layer as a whole, and a preferred exemplary embodiment of the distribution of a water-soluble zirconium compound in the thickness direction of the ink-receiving layer as a whole, are described.

From the viewpoints of color developability, prevention of bronzing, and the like, the distribution of a water-soluble zirconium compound in the ink-receiving layer as a whole is preferably such that a larger amount of the water-soluble zirconium compound is present in a portion of the ink-receiving layer as a whole that is farther from the substrate (preferably in the vicinity of the upper surface of the ink-receiving layer as a whole).

On the other hand, the distribution of a water-soluble aluminum compound in the ink-receiving layer as a whole is preferably such that a larger amount of the water-soluble aluminum compound is present in a portion of the ink-receiving layer as a whole that is nearer the substrate.

In the invention, it is feasible to ascertain the distributions of a water-soluble aluminum compound and a water-soluble zirconium compound in the thickness direction of the ink-receiving layer as a whole by preparing a vertical-section sample of the ink-receiving layer using, for example, a microtome, and measuring the sample for levels of aluminum and zirconium elements in the thickness direction of the ink-receiving layer using, for example, an EPMA (Electron Probe Micro Analyzer).

Hereinafter, ingredients included in the ink-receiving layers are described in detail.

### Pigment

The ink-receiving layers (which include at least the first layer and the second layer, and may include another layer as required) include pigments.

There is no particular restriction as to the pigments, but fine-particle silica is suitable for use. The fine-particle silica suitable herein may be at least one of synthetic silica products such as vapor-phase process silica and wet process silica.

The vapor-phase process silica is also referred to as “dry process silica”. The dry process silica is generally produced by a flame hydrolysis process. More specifically, a process of producing the dry silica is generally known in which silicon tetrachloride is burned together with hydrogen and oxygen. Meanwhile, instead of using silicon tetrachloride, it is also possible to produce a dry process silica by using alone a silane compound such as methyltrichlorosilane or trichlorosilane, or by using a mixture of such a silane compound with silicon tetrachloride. The vapor-phase process silica is marketed and available from NIPPON AEROSIL Co., Ltd. under the trade name of AEROSIL and from TOKUYAMA Corporation under the registered name of REOLOSIL® QS series.

The average primary-particle size of the vapor-phase process silica is preferably from 5 nm to 50 nm. In order to achieve higher glossiness, a vapor-phase process silica is used which has an average primary-particle size of from 5 nm to 20 nm and a specific surface area of from 90 to 400 m²/g as determined by the BET method. The BET (Brunauer, Emmett, Teller) method is one of methods for determining surface areas of fine particles by use of a gas-phase adsorption method, and is a method of determining the total surface area of fine particles included in 1 g of a sample (i.e., the specific surface area of fine particles in a sample) from an adsorption isotherm line. In the BET method, the gas used for adsorption in many usual cases is nitrogen gas, and a method is most frequently used in which the amount of an adsorbed gas is determined in accordance with a change in pressure or volume of the gas to be adsorbed. The most famous equation expressing the isotherm line of multilayer molecular adsorption is the Brunauer-Emmett-Teller equation referred to as the BET equation, and widely used for determination of a surface area. The surface area is obtained by determining the amount of adsorbed gas based on the BET equation and multiplying the amount by the area that one adsorbed molecule occupies on a particle surface.

The vapor-phase process silica is present in a state that primary particles having sizes of several to several tens nanometers are secondarily flocculated by forming a reticular structure or being linked to one another to form chains. It is appropriate that these flocculated particles (secondary particles) be dispersed until the average particle size thereof reaches 500 nm or less, and preferably 300 nm or less. The lower limit of the size of the secondary particles is about 50 nm. Herein, the average particle size of the flocculated particles can be determined by photography with a transmission electron microscope. Alternatively, the average particle size can be determined simply and easily as a number median diameter by use of a laser scattering particle size distribution analyzer (e.g., LA910, trade name, manufactured by Horiba, Ltd.).

The silica products manufactured by wet processes can be further classified into precipitation process silica, gel process silica and sol process silica, according to their manufacturing methods. The precipitation process silica can be manufactured by reaction between sodium silicate and sulfuric acid under an alkaline condition. Silica particles grown in a manufacturing process are flocculated and precipitated, and then subjected to filtration, washing with water, drying, grinding and classification in sequence. Since the secondary particles of silica manufactured by this process are in a gently flocculated state, the secondary particles are relatively easily ground. The precipitation process silica is commercially available, e.g., from TOSOH SILICA CORPORATION under the trade name of NIPSIL or from TOKUYAMA Corporation under the registered names of TOKUSIL® and FINESIL®.

The gel process silica is manufactured by reaction between sodium silicate and sulfuric acid under an acidic condition. In this case, small silica particles are dissolved during aging and re-precipitated so as to bind relatively large primary silica particles. Thus, definite primary particles disappear, and relatively hard flocculated particles having a porous internal structure are formed. This type of silica is commercially available, e.g., from MIZUSAWA INDUSTRIAL CHEMICALS, LTD. under the registered name of MIZUKASIL® or from Grace Japan K.K. under the trade name of SILOJET.

The sol process silica is also referred to as “colloidal silica”, and obtained by thermally aging silica sol produced by metathetic reaction of sodium silicate with an acid or the like or by passing sodium silicate through an ion-exchange resin layer. The type of silica is commercially available, e.g., from Nissan Chemical Industries, Ltd. under the trade name of SNOWTEX.

Examples of the wet process silica to be used in the invention include the precipitation process silica and the gel process silica. The wet process silica generally has an average particle size (average secondary-particle size) of 1 μm or larger. In the invention, it is preferred that such wet process silica undergo a grinding operation until the average particle size thereof reaches 500 nm or less, and preferably 300 nm or less. The lower limit of the average particle size is about 50 nm. The particle sizes of the wet process silica having undergone a grinding operation can be determined using a transmission electron microscope or a laser scattering particle size distribution analyzer as mentioned hereinbefore.

The grinding operation for the wet process silica preferably includes a primary dispersion step in which fine particles of silica are added to and mixed in a dispersion medium (preliminary dispersion) and a secondary dispersion step in which the silica particles in the crude dispersion solution obtained in the primary dispersion step are ground. The preliminary dispersion in the primary dispersion step can be performed, e.g., by usual propeller agitation, agitation with a dentate-blade dispersing device, turbine agitation, homomixer agitation or ultrasonic agitation. As a grinding method for the wet process silica, a wet dispersion method in which the silica dispersed in a dispersion medium is ground mechanically can be used suitably. Examples of a usable wet dispersing machine include a media mill such as a ball mill, a bead mill or a sand grinder, a pressure dispersing machine such as a high-pressure homogenizer or an ultrahigh-pressure homogenizer, an ultrasonic dispersing machine and a thin-film rotary dispersing machine. Of these machines, a media mill such as a bead mill is preferably used.

The average particle size (average secondary-particle size) of the wet process silica is preferably 5 μm or larger. By grinding silica having a relatively large particle size, dispersion in a higher concentration becomes feasible. Although the upper limit of the average particle size of the wet process silica is not particularly limited, the average particle size of the wet process silica is generally 200 μm or less.

Additionally, precipitation process silica is preferred as the wet process silica. As mentioned above, since the secondary particles of the precipitation process silica are gently flocculated particles, the precipitation process silica are suitable for being ground.

In the invention, it is preferable that the pigment such as fine-particle silica is cationized by addition of a cationic polymer. The cationic polymer may be added during the dispersion or grinding process. The cationic polymer usable herein is described later.

Of the pigments which may be used in the invention, the vapor-phase process silica is preferred from the viewpoints of ink absorbency and color developability.

One of the pigments may be used alone, or a combination of two or more thereof may be used.

The total amount of pigments included in each ink-receiving layer is, though not particularly limited, preferably at least 60% by mass, more preferably at least 65% by mass, particularly preferably at least 70% by mass, with respect to the total amount of solids included in the ink-receiving layer. The upper limit of the total amount of pigments is about 95% by mass.

Binder

The ink-receiving layers in the invention (which include at least the first layer and the second layer, and may further include another layer as required) include binders.

The binders are not particularly limited, but it is advantageous to use a hydrophilic binder from the viewpoints of retaining characteristics as a film and achieving high transparency and higher ink permeability.

Examples of such a hydrophilic binder include polyvinyl alcohol, polyethylene glycol, starch, dextrin, carboxymethylcellulose, and derivatives thereof. Of these hydrophilic binders, a completely saponified polyvinyl alcohol or a partially saponified polyvinyl alcohol is especially preferred. As the polyvinyl alcohol, partially- or completely-saponified polyvinyl alcohol having a saponification degree of 80% or higher is particularly preferably used. An average polymerization degree of the polyvinyl alcohol is preferably from 500 to 5,000.

At least 80% by mass of the sum total (total amount) of the binders included in the ink receiving layers (including the first layer and the second layer) is a partially- or completely-saponified polyvinyl alcohol having a saponification degree of 95% or higher.

One of the binders may be used alone, or a combination of two or more thereof may be used. The same or different binder(s) may be included in the respective layers.

The ratio by mass of the binder (B; the hydrophilic binder, for example) to the pigment (P; the fine-particle silica, for example), or the B/P ratio, in each ink-receiving layer is preferably in a range of from 5% to 30% by mass, and more preferably from 5% to 25% by mass.

In order to allow an ink to pass smoothly from the first layer that is located farther from the substrate to the second layer that is located nearer the substrate, the B/P ratio by mass in the first layer is preferably lower than that in the second layer.

Water-Soluble Zirconium Compound

At least one of the ink-receiving layers (i.e., at least the first layer, and, as required, another layer) includes a water-soluble zirconium compound. Specifically, at least the first layer includes a water-soluble zirconium compound, and another layer may include a water-soluble zirconium compound.

The water-soluble zirconium compound for use in the invention may be an inorganic salt, a single or double salt of an organic acid, or a metal complex.

Examples of such a water-soluble zirconium compound include zirconium acetate, zirconium nitrate, basic zirconium carbonate, zirconium hydroxide, ammonium zirconium carbonate, potassium zirconium carbonate, zirconium sulfate, zirconium fluoride, zirconium chloride, zirconium chloride octahydrate, zirconium oxychloride, and zirconium hydroxychloride.

Of these water-soluble zirconium compounds, those which can be added stably to a coating solution for formation of the ink-receiving layer, and zirconium acetate (zirconyl acetate) and zirconium oxychloride are particularly preferred.

Such compounds are commercially available from DAIICHI KIGENSO KAGAKU KOGYO CO., LTD. under the trade names of ZIRCOSOL ZA-20, ZIRCOSOL ZA-30, ZIRCOSOL ZC-2 and the like. Also, these compounds are commercially available from Nippon Light Metal Co., Ltd.

One of the water-soluble zirconium compounds may be used alone, or a combination of two or more thereof may be used.

Water-Soluble Aluminum Compound

At least one of the ink-receiving layers in the invention (i.e., at least the second layer, and, as required, another layer) includes a water-soluble aluminum compound. Specifically, at least the second layer includes a water-soluble zirconium compound, and another layer may include a water-soluble zirconium compound.

The water-soluble aluminum compound for use in the invention may be an inorganic salt, a single or double salt of an organic acid, or a metal complex.

Examples of the water-soluble aluminum compound usable in the invention include: inorganic salts thereof such as aluminum chloride or a hydrate thereof, aluminum sulfate or a hydrate thereof, and ammonium alum; and inorganic aluminum-containing cationic polymers such as a basic polyaluminum hydroxide compound.

Of those water-soluble aluminum compounds, those which can be added stably to a coating solution for formation of the ink-receiving layer are preferred, and a basic polyaluminum hydroxide compound is preferably used. The basic polyaluminum hydroxide compound includes components each represented by the following Formula 1, 2 or 3. An example thereof is a water-soluble polyaluminum hydroxide which stably contains a basic polymeric polynuclear condensed ion, such as [Al₆(OH)₁₅]³⁺, [Al₈(OH)₂₀]⁴⁺, [Al₁₃(OH)₃₄]⁵⁺ or [Al₂₁(OH)₆₀]^{3′}.

[Al₂(OH)ₙCl₆₋ₙ]ₘ Formula 1

[Al(OH)₃]ₙAlCl₃ Formula 2

Alₙ(OH)ₘCl(₃ₙ₋ₘ₎ 0<m<3n Formula 3

These compounds are commercially available from TAKI CHEMICAL CO., LTD. as a water treatment chemical under the name of POLYALUMINUM CHLORIDE (PAC), from Asada Chemical Industry Co., Ltd. under the name of POLYALUMINUM HYDROXIDE (Paho), from TAIMEI CHEMICALS CO., LTD. under the trade name of ALFINE, and from Rikengreen Co., Ltd. under the trade name of PURACHEM WT. In addition, other makers also provide water-soluble aluminum compounds with the same purpose, and various grades thereof are readily available. In the invention, any of those commercial products can be used without modification or the like.

One of the water-soluble aluminum compounds may be used alone, or a combination of two or more thereof may be used.

Other Ingredients Each of the ink-receiving layers may include an ingredient other than the above-mentioned components, as required.

### Cationic Polymer

Each of the ink-receiving layers may include a cationic polymer for the purpose of cationizing a pigment, such as fine-particle silica, as mentioned above, or other purposes.

Examples of the cationic polymer include a water-soluble cationic polymer having a quaternary ammonium group, a phosphonium group, or an acid adduct of a primary to tertiary amine. Specific examples of such a cationic polymer include polyethyleneimine, polydialkyldiallylamine, polyallylamine, alkylamine-epichlorohydrin polycondensates, and the cationic polymers disclosed in JP-A Nos. 59-20696, 59-33176, 59-33177, 59-155088, 60-11389, 60-49990, 60-83882, 60-109894, 62-198493, 63-49478, 63-115780, 63-280681, 1-40371, 6-234268, 7-125411 and 10-193776, WO 99/64248, and the like. The weight-average molecular weight of a cationic polymer used in the invention is preferably 1.0×10⁵ or below, far preferably 100,000 or below, and particularly preferably from about 2,000 to about 30,000.

In the invention, the amount of the cationic polymer in each of the ink-receiving layer is preferably from 1% to 10% by mass with respect to the mass of the pigment such as fine-particle silica in each of the ink-receiving layer.

Hardener

Each of the ink-receiving layers preferably includes a hardener in combination with a binder.

Examples of a hardener usable herein include an aldehyde compound such as formaldehyde or glutaraldehyde, a ketone compound such as diacetyl or chloropentanedione, a reactive halogen-containing compound such as bis(2-chloroethylurea)-2-hydroxy-4,6-dichloro-1,3,5-triazine or the compound disclosed in U.S. Pat. No. 3,288,775, a reactive olefin-containing compound such as divinyl sulfone or the compound disclosed in U.S. Pat. No. 3,635,718, the N-methylol compounds disclosed in U.S. Pat. No. 2,732,316, the isocyanates as disclosed in U.S. Pat. No. 3,103,437, the aziridine compounds as disclosed in U.S. Pat. Nos. 3,017,280 and 2,983,611, the carbodiimide compounds as disclosed in U.S. Pat. No. 3,100,704, the epoxy compounds as disclosed in U.S. Pat. No. 3,091,537, halogenocarboxyaldehydes such as mucochloric acid, dioxane derivatives such as dihydroxydioxane, and an inorganic hardener such as chrome alum, zirconium sulfate, boric acid or a borate. One of these hardeners can be used alone, or a combination of two or more thereof may be used. Of those hardeners, boric acid or a borate in particular is preferred.

The amount of a hardener included in each ink-receiving layer is preferably from 0.1% to 40% by mass, more preferably from 0.5% to 30% by mass, with respect to the binder in each ink-receiving layer.

Other Additives

Each of the ink-receiving layers may further include any of various kinds of known additives such as coloring dyes, coloring pigments, ultraviolet absorbents, antioxidants, dispersants for pigments, defoaming agents, leveling agents, preservatives, fluorescent whiteners, viscosity stabilizers and pH regulators.

The pH of coating solutions used for formation of the ink-receiving layers (e.g., coating solution A and coating solution B described later) is preferably in a range of from 3.3 to 6.5, and particularly preferably in a range of from 3.5 to 5.5.

Further, addition of a thioether compound, carbohydrazide or a derivative thereof to each of the ink-receiving layers can contribute to considerable improvement in storage stability after printing.

The carbohydrazide derivative may be either a compound having one or more than one carbohydrazide structure in one molecule, or a polymer having a carbohydrazide structure in its main chain or side chains.

Examples of the thioether compound include an aromatic thioether compound in which aromatic groups are bonded to both sides of a sulfur atom and an aliphatic thioether compound having alkyl groups on both sides of the compound with a sulfur atom interposed between the alkyl groups. Of these compounds, an aliphatic thioether compound further having a hydrophilic group is preferred.

Such compounds can be synthesized by known synthetic methods, or by reference to the synthetic methods as disclosed in JP-A Nos. 2002-321447 and 2003-48372. As to some of those compounds, commercially available chemical products can be used without modification or the like.

Waterproof Substrate

Examples of a waterproof substrate for use in the invention include: a plastic resin film formed from a polyester resin such as polyethylene terephthalate, a diacetate resin, a triacetate resin, an acrylic resin, a polycarbonate resin, polyvinyl chloride, a polyimide resin, cellophane or Celluloid; resin film-laminated paper; and polyolefin resin-coated paper formed from base paper and polyolefin resin layers covering both sides of the base paper. The thickness of such a waterproof substrate is from 50 μm to 300 μm, and preferably from 80 μm to 260 μm.

Hereinafter, the polyolefin resin-coated paper preferably used as the waterproof substrate in the invention is described in detail.

The polyolefin resin-coated paper has no particular restriction as to a moisture content thereof. From the viewpoint of curling properties, however, the moisture content is preferably in a range of from 5.0 to 9.0%, and more preferably in a range of from 6.0 to 9.0%. The moisture content in a polyolefin resin-coated paper can be measured by any of known moisture-content measurement methods. For instance, an infrared moisture-measuring system, a bone-dry weight measurement method, a permittivity measurement method, or the Karl Fischer's method can be employed.

The base paper of the polyolefin resin-coated paper is not particularly limited. Paper in common use can be used as the base paper, and smooth raw paper as used, e.g., for a photographic substrate is more suitably used. Examples of pulp used as a constituent of the base paper include natural pulp, regenerated pulp, synthetic pulp and a mixture of at least two of these pulp materials. The base paper may further include an additive generally used in paper making. Examples of the additive include a sizing agent, a paper durability-enhancing agent, a filler, an antistatic agent, a fluorescent whitener and a dye.

Further, the base paper surfaces may be coated with a surface sizing agent, a paper surface durability enhancer, a fluorescent whitener, a dye, an anchoring agent, or the like.

The thickness of the base paper is not particularly limited. It is preferable that good surface smoothness be given to the base paper by compressing paper, e.g., under pressure applied by calendering during the papermaking or after papermaking. The basis weight of base paper is preferably from 30 to 250 g/m².

Examples of the polyolefin resin with which base paper is coated include an olefin homopolymer such as a low-density polyethylene, a high-density polyethylene, polypropylene, polybutene or polypentene, a copolymer of two or more olefins, such as an ethylene-propylene copolymer, and a mixture thereof. These polyolefin resins have different degrees of densities and melt viscosity indices (melt indices), and one of them may be used alone, or a mixture of two or more thereof may be used.

Further, it is preferable that various additives in combination as appropriate are added in advance to the resin of the polyolefin resin-coated paper. Examples of such additives include a white pigment such as titanium oxide, zinc oxide, talc or calcium carbonate, a fatty acid amide such as stearic acid amide or arachidic acid amide, a metal salt of fatty acid such as zinc stearate, calcium stearate, aluminum stearate or magnesium stearate, an antioxidant such as IRGANOX 1010 or IRGANOX 1076 (registered name, manufactured by Ciba), a blue pigment or dye such as cobalt blue, ultramarine blue, cecilian blue or phthalocyanine blue, a magenta pigment or dye such as cobalt violet, Fast Violet or manganese purple, a fluorescent whitener, and a ultraviolet absorbent.

The polyolefin-coated paper may be mainly made by flow casting of a polyolefin resin in a hot-melt state onto traveling base paper, or the so-called extrusion coating method; as a result, both sides of the base paper are coated with the resin. In addition, it is preferred that, prior to coating the base paper with the resin, activation treatment such as corona discharge treatment or flame treatment be given to the base paper. The suitable thickness of the resin coating is from 5 μm to 50 μm.

The waterproof substrate used in the invention is preferably provided with an undercoat layer on the side where ink-receiving layers are to be applied. The undercoat layer is a layer formed by coating and drying on the surface of a waterproof substrate in advance of providing ink-receiving layers. The undercoat layer includes as a main component a film-formable water-soluble polymer, polymer latex or the like. The main component is preferably a water-soluble polymer, such as gelatin, polyvinyl alcohol, polyvinyl pyrrolidone or water-soluble cellulose, and particularly preferably gelatin. The adhesion amount of such a water-soluble polymer is preferably from 10 to 500 mg/m², and more preferably from 20 to 300 mg/m². In addition, it is preferred that the undercoat layer further include a surfactant or a hardener. The undercoat layer provided on the substrate can effectively prevent occurrence of cracks during the coating of ink-receiving layers and contribute to uniform coating-surface formation.

For the purpose of preventing curling and enhancing resistance to sticking and setoff troubles occurring when recording materials are superposed on top of each other just after printing, various types of back layers may be provided on the side of the substrate opposite to the ink absorption side of the inkjet recording material.

Method for Manufacturing Inkjet Recording Material

The method for manufacturing the inkjet recording material is not particularly limited. The inkjet recording material may be manufactured by the following method, for example.

Specifically, the manufacturing method of the present inkjet recording material includes a process of forming ink-receiving layers by coating a waterproof substrate with coating solution A that includes at least a binder, a pigment and a water-soluble zirconium compound and then with coating solution B that includes at least a pigment, a binder and a water-soluble aluminum compound, the amount of water-soluble aluminum compound in coating solution B being larger than that in coating solution A, so that the layer formed from the coating solution B and the layer formed from the coating solution A are provided on the waterproof substrate in this order. Herein, 80% or more by mass of the total amount of binders included in all of the coating solutions for forming the ink-receiving layers is a polyvinyl alcohol having a saponification degree of 95% or higher.

For the binder, the pigment and the water-soluble zirconium compound which are included in coating solution A and the other components used therein as required, the ingredients described above with respect to the first layer can be used.

Likewise, for the binder, the pigment and the water-soluble aluminum compound which are included in coating solution B and the other components used therein as required, the ingredients described above with respect to the second layer can be used.

For the other components which may be included in the respective coating solutions, the additional ingredients mixed in each of the ink-receiving layers can be used.

The binder compositions in the coating solutions are the same as those in the corresponding ink-receiving layers, and the same preferred ranges apply.

The waterproof substrate, the distribution of a water-soluble zirconium compound, the distribution of a water-soluble aluminum compound, and so on, are the same as those described above with respect to the inkjet recording material.

In the manufacturing method, the method for applying coating solution A and coating solution B (and other coating solutions used as required) is not particularly limited as long as the layer formed from the coating solution B and the layer formed from the coating solution A are provided on the waterproof substrate in this order.

For instance, the coating method may be either a sequential coating method in which layers are formed one after another (using, for example, a blade coater, an air knife coater, a roll coater, a bar coater, a gravure coater or a reverse coater) or a simultaneous multilayer superposition coating method (using, for example, a slide bead coater or a slide curtain coater). Alternatively, the “Wet-on-wet method” disclosed in JP-A No. 2005-14593, paragraph nos. 0016 to 0037, may be employed.

Of these methods, a simultaneous multilayer superposition coating method is preferred over the others.

The dry coating amount of the coating solution A is preferably 8 g/m² or less, and more preferably in the range of from 1 to 7 g/m², from the viewpoint of allowing a water-soluble zirconium compound to distribute at a high density in the vicinity of the ink-receiving layer surface with efficiency.

The dry coating amount of the coating solution B is preferably 12 g/m² or more, and more preferably 15 g/m² or more, from the viewpoint of ensuring sufficient ink absorption speed and sufficient ink capacity.

Preparation of Coating Solution

Examples of a preparation method of a coating solution (such as Coating Solution A or Coating Solution B) for formation of an ink-receiving layer are described below.

Specifically, a coating solution can be prepared by adding fine particles of vapor-phase process silica as a pigment and a dispersant to water (so that the fine-particle silica content in water falls within a range of, for example, from 10 to 20% by mass), dispersing the pigment using a wet colloid mill of rapidly rotating type (e.g., CLEARMIX, trade name, manufactured by M TECHNIQUE) for, for example, 20 minutes (preferably from 10 minutes to 30 minutes) under conditions of high-speed rotation at, for example, 10,000 rpm (preferably from 5,000 to 20,000 rpm), adding to the resultant dispersion liquid a crosslinking agent (e.g., boric acid), an aqueous solution of polyvinyl alcohol (PVA) (in an amount such that the PVA content will be about one-third by mass of the vapor-phase process silica content) and a cationic emulsion, further adding thereto the water-soluble polyvalent metal compound(s) (e.g., a water-soluble zirconium compound and/or a water-soluble aluminum compound), and then subjecting the resultant mixture to a dispersing operation under the same rotation conditions as mentioned above.

Alternatively, the addition of water-soluble polyvalent metal compound(s) may be carried out by in-line mixing just before coating.

The dispersing operation also may be performed using a liquid-liquid collision disperser (e.g., ULTIMIZER manufactured by SUGINO MACHINE LIMITED).

The coating solution thus obtained is in a uniform sol state. This solution is applied on a substrate according to the coating method as mentioned hereinafter, and then dried, whereby a porous ink-receiving layer having a three-dimensional reticular structure can be formed.

Alternatively, an aqueous dispersion including the vapor-phase process silica and a dispersant may be prepared by preparing an aqueous dispersion of vapor-phase process silica in advance, and then adding the silica aqueous dispersion to an aqueous dispersion of dispersant, or adding an aqueous dispersion of dispersant to the aqueous dispersion of vapor-phase process silica. The aqueous dispersion of vapor-phase process silica and the aqueous dispersion of dispersant may be mixed simultaneously. Instead of using the aqueous dispersion of vapor-phase process silica, vapor-phase process silica powder may be added to the aqueous dispersion of dispersant.

After the vapor-phase process silica and the dispersant are mixed, the mixture solution is subjected to grain fining by use of a dispersing machine. Thus, an aqueous dispersion in which the average particle size of the silica is from 50 nm to 300 nm can be obtained. Heretofore, known various dispersing machines can be used for preparation of such an aqueous dispersion, with examples including a high speed rotary disperser, a media agitation disperser (such as a ball mill or a sand mill), an ultrasonic disperser, a colloidal mill disperser and a high-pressure disperser. From the viewpoint of efficiently performing dispersion of flocculated fine particles to be formed, an agitation disperser, a colloidal mill disperser or a high-pressure disperser may be preferably used.

The solvent usable in each step may be water, an organic solvent or a mixture of them. Examples of an organic solvent usable in the coating step include alcohols such as methanol, ethanol, n-propanol, i-propanol or methoxypropanol, ketones such as acetone or methyl ethyl ketone, tetrahydrofuran, acetonitrile, ethyl acetate and toluene.

As the dispersant, a cationic polymer can be used. Examples of such a cationic polymer include the mordants disclosed in JP-A No. 2006-321176, paragraph Nos. 0138 to 0148. In addition, it is also advantageous to use a silane coupling agent as the dispersant.

The amount of the dispersant to be added is preferably from 0.1 to 30% by mass, and more preferably from 1 to 10% by mass, with respect to the mass of the particles.

Cooling Process, Drying Process, and the Like

In the manufacturing method of the inkjet recording material, another process such as a cooling process or a drying process may be provided after the coating solution A and the coating solution B are applied.

One exemplary embodiment of a combination of cooling and drying steps is, e.g., as follows.

Specifically, the coating film which has been formed by coating is cooled to a temperature at least 5° C. lower than the temperature of the coating solution at the time of the coating (hereinafter may also be referred to as a cooling process), and the cooled coating layer may be dried to form an ink-receiving layer (hereinafter may also be referred to as a drying process).

In the exemplary embodiment, the suitable method of cooling the coating layer in the cooling process may be a method of cooling a coating layer-bearing substrate for 5 to 30 seconds in a cooling zone kept at a temperature of from 0 to 10° C., and preferably from 0 to 5° C.

Herein, the temperature of the coating layer may be determined by measuring the temperature of the coating layer surface.

After formation of an ink-receiving layer on a substrate, the ink-receiving layer may further undergo, for example, calendering treatment using, e.g., supercalender or glosscalender in which the ink-receiving layer is made to pass between roll nips under heated and pressurized conditions, whereby surface smoothness, glossiness, transparency and coating layer strength can be enhanced.

From the viewpoint of porosity, suitable conditions for the calendering treatment are as follows.

Specifically, the roll temperature during the calendering treatment is preferably from 30 to 150° C., and more preferably from 40 to 100° C., and the linear pressure between rolls during the calendering treatment is preferably from 50 to 400 kg/cm, and more preferably from 100 to 200 kg/cm.

Hereinafter, exemplary embodiments of the present invention are described.

(1) An inkjet recording material, including:

a waterproof substrate; and

at least two ink-receiving layers that are provided on the waterproof substrate and include a first ink-receiving layer and a second ink-receiving layer,

wherein the second ink-receiving layer is located at a position nearer to the waterproof substrate than the first ink-receiving layer,

the first ink-receiving layer includes a pigment, a water-soluble zirconium compound, and a binder,

the second ink-receiving layer includes a pigment, a binder, and a water-soluble aluminum compound, the amount of the water-soluble aluminum compound being larger than that of a water-soluble aluminum compound included in the first ink-receiving layer, and

at least 80% by mass of the binders included in the at least two ink-receiving layers includes a polyvinyl alcohol having a saponification degree of 95% or higher.

(2) The inkjet recording material according to (1), wherein at least 85% by mass of the binders included in the at least two ink-receiving layers includes a polyvinyl alcohol having a saponification degree of 95% or higher.

(3) The inkjet recording material according to (1), wherein the mass ratio of the water-soluble aluminum compound included in the first ink-receiving layer to the water-soluble aluminum compound included in the second ink-receiving layer is from 0 to less than 1.0.

(4) The inkjet recording material according to (1), wherein the amount of the water-soluble zirconium compound included in the first ink-receiving layer is from 0.5 to 15% by mass with respect to the mass of the pigment in the first ink-receiving layer.

(5) The inkjet recording material according to (1), wherein the amount of the water-soluble aluminum compound included in the second ink-receiving layer is from 0.5 to 15% by mass with respect to the mass of the pigment in the second ink-receiving layer.

(6) The inkjet recording material according to (1), wherein the binder included in the first ink-receiving layer includes a polyvinyl alcohol having a polymerization degree of 2,000 or less, and the binder included in the second ink-receiving layer includes a polyvinyl alcohol having a polymerization degree of 2,000 or more.

(7) The inkjet recording material according to (6), wherein the binder included in the first ink-receiving layer includes a polyvinyl alcohol having a polymerization degree of 1,900 or less, and the binder included in the second ink-receiving layer includes a polyvinyl alcohol having a polymerization degree of 3,000 or more.

(8) The inkjet recording material according to (1), wherein the pigment included in the first ink-receiving layer and the pigment included in the second ink-receiving layer include silica particles.

(9) The inkjet recording material according to (8), wherein the silica particles are vapor-phase silica.

(10) The inkjet recording material according to (1), wherein the total amount of the pigments included in the at least two ink-receiving layers is 60% by mass or more with respect to the total solid content of the at least two ink-receiving layers.

(11) The inkjet recording material according to (1), wherein a dry coating amount of the first ink-receiving layer is 8 g/m² or more.

(12) The inkjet recording material according to (1), wherein a dry coating amount of the second ink-receiving layer is 12 g/m² or more.

(13) A method for manufacturing an inkjet recording material, including:

applying coating solution B including a binder, a pigment, and a water-soluble aluminum compound and a coating solution A including a binder, a pigment, and a water-soluble zirconium compound on a waterproof substrate such that the coating solution B and the coating solution A are applied on the waterproof substrate in this order,

wherein the amount of the water-soluble aluminum compound included in the coating solution B is larger than that of a water-soluble aluminum compound included in the coating solution A, and

wherein at least 80% by mass of the binders included in the coating solutions A and B for forming ink-receiving layers includes a polyvinyl alcohol having a saponification degree of 95% or more.

(14) The method for manufacturing an inkjet recording material according to (13), wherein the mass ratio of the water-soluble aluminum compound included in the coating solution A to the water-soluble aluminum compound included in the coating solution B is from 0 to less than 1.0.

(15) The method for manufacturing an inkjet recording material according to (13), wherein the binder included in the coating solution A includes a polyvinyl alcohol having a polymerization degree of 2,000 or less, and the binder included in the coating solution B includes a polyvinyl alcohol having a polymerization degree of 2,000 or more.

(16) The method for manufacturing an inkjet recording material according to (13), wherein the amount of the water-soluble zirconium compound included in the coating solution A is from 0.5 to 15% by mass with respect to the mass of the pigment in the coating solution A.

(17) The method for manufacturing an inkjet recording material according to (13), wherein the amount of the water-soluble aluminum compound included in the coating solution B is from 0.5 to 15% by mass with respect to the mass of the pigment in the coating solution B.

(18) The method for manufacturing an inkjet recording material according to (13), wherein a dry coating amount of the coating solution A is 8 g/m² or more.

(19) The method for manufacturing an inkjet recording material according to (13), wherein a dry coating amount of the coating solution B is 12 g/m² or more.

All publications, patent applications, and technical standards mentioned in this specification are herein incorporated by reference to the same extent as if each individual publication, patent application, or technical standard was specifically and individually indicated to be incorporated by reference.

### EXAMPLES

The invention will now be illustrated in more detail by referring to the following examples. However, various changes and modifications can be made so long as they do not depart from the spirit and scope of the invention, and the invention should not be construed as being limited to the following examples. Additionally, all “part(s)” and “percentage(s) (%)” in the following examples respectively indicate “part(s) by mass” and “percentage(s) by mass” unless otherwise indicated.

### Example 1

### Preparation of Waterproof Substrate

A pulp slurry was prepared by beating 50 parts of acacia-derived LBKP (bleached hardwood kraft pulp) and 50 parts of aspen-derived LBKP with a disk refiner so that the pulp had Canadian freeness of 300 ml.

To the thus-obtained pulp slurry were added 1.3% of cationic starch (CATO 304L, manufactured by Nippon NSC Ltd.), 0.15% of anionic polyacrylamide (POLYACRON ST-13, manufactured by Seiko Chemicals Co., Ltd.), 0.29% of alkylketene dimer (SIZEPINE K, manufactured by Arakawa Chemical Industries, Ltd.), 0.29% of epoxidized behenic acid amide and 0.32% of polyamidepolyamine epichlorohydrin (ARAFIX 100, manufactured by Arakawa Chemical Industries, Ltd.), percentages expressing an amount with respect to the amount of the pulp. Then, 0.12% of a defoaming agent was further added.

The thus-prepared pulp slurry was made into paper using a Fourdrinier paper machine, and dried by pressing the felt side of the web against a drum dryer cylinder via a dryer canvas and setting the tensile strength of the dryer canvas to 1.6 kg/cm. The thus-obtained raw paper was coated with a polyvinyl alcohol (KL-118, manufactured by Kuraray Co., Ltd.) in an amount of 1 g/m² on either side using a size press, dried and further subjected to calendering treatment. Further, the raw paper was configured to have a basis weight of 166 g/m², and the thickness of raw paper (base paper) obtained was 160 μm.

After the wire side (back side) of the thus obtained base paper was subjected to corona discharge treatment, the wire side (back side) of the thus obtained base paper was coated with a high-density polyethylene using a melt extrusion machine so that the polyethylene had a layer thickness of 25 μm. Thus, a thermoplastic resin layer having a matte surface was formed (hereinafter, the side of this thermoplastic resin layer is referred to as “the back side”). The thermoplastic resin layer on the back side was further subjected to corona discharge treatment, and an antistatic agent was applied thereto. The antistatic agent was prepared as a dispersion liquid by dispersing 1:2 by mass mixture of aluminum oxide (ALUMINA SOL 100, manufactured by Nissan Chemical Industries, Ltd.) and silicon dioxide (SNOWTEX O, manufactured by Nissan Chemical Industries, Ltd.) into water. The dry coating amount of the antistatic agent was 0.2 g/m².

Further, the felt side (front side) of the base paper, on which no thermoplastic resin layer had yet been provided, was subjected to corona discharge treatment and, thereon, a low-density polyethylene having an MFR (melt flow rate) of 3.8 was extruded in a thickness of 25 μm using a melt extrusion machine, thereby forming a high-gloss thermoplastic resin layer on the front side of the base paper (hereinafter, this high-gloss side is referred to as the front side). The low-density polyethylene was prepared so as to include 10% of anatase-type titanium oxide, 0.3% of ultramarine blue (manufactured by TOKYO PRINTING INK MFG CO., LTD.) and 0.08% of fluorescent whitener (WHITEFLOUR PSN CONC, manufactured by Nippon Chemical Industrial Co., Ltd.). Thus, a waterproof substrate was made. The waterproof substrate was cut into long rolls having dimensions of a width of 1.5 m and a roll length of 3,000 m.

In the foregoing manner, the waterproof substrate was obtained.

Preparation of Coating Solution A1 for Ink-Receiving Layer

A coating solution A1 (Coating Solution A) for forming an ink-receiving layer, having the following composition was prepared by mixing (1) fine particles of vapor-phase process silica, (2) ion exchange water, (3) SHAROLL DC-902P and (4) ZA-30, subjecting the resultant mixture to a dispersing operation using an ultrasonic dispersing machine (made by SMT Co., Ltd.), and then heating the resultant dispersion liquid at 45° C. and keeping it for 20 hours, and further adding (5) boric acid and (6) a polyvinyl alcohol solution to the dispersion liquid at 30° C.

Composition of Coating Solution A1 for Ink-Receiving Layer

| | | |
|---|---|---|
| (1) | Fine particles of vapor-phase process silica (pigment) | 10.0 parts |
| | (AEROSIL 300SV, manufactured by Nippon Aerosil) | |
| (2) | Ion exchange water | 62.8 parts |
| (3) | SHAROLL DC-902P (51.5% aqueous solution) | 0.87 parts |
| | (dispersant, manufactured by Dai-ichi | |
| | Kogyo Seiyaku Co., Ltd.) | |
| (4) | ZA-30 (zirconyl acetate, manufactured by DAIICHI | 0.54 parts |
| | KIGENSO KAGAKU KOGYO CO., | |
| | LTD.; water-soluble zirconium compound) | |
| (5) | Boric acid (crosslinking agent) | 0.44 pars |
| (6) | Polyvinyl alcohol (binder) solution | 34.9 parts |

The composition of the polyvinyl alcohol solution was as follows.

Composition of Polyvinyl Alcohol Solution

| | |
|---|---|
| PVA-117 manufactured by Kuraray Co., Ltd. | 2.43 parts |
| (saponification degree: 99%, polymerization degree: 1,700) | |
| Polyoxyethylene lauryl ether (surfactant) (EMULGEN 109P, | 0.03 parts |
| 10% aqueous solution, HLB value: 13.6, | |
| manufactured by Kao Corporation) | |
| Diethylene glycol monobutyl ether (BUTYCENOL 20P, | 0.74 parts |
| manufactured by KYOWA HAKKO CHEMICAL CO., LTD.) | |
| Ion exchange water | 31.0 parts |

Preparation of Coating Solution B1 for Ink-Receiving Layer

A coating solution B1 (Coating Solution B) for forming an ink-receiving layer, having the following composition was prepared by mixing (1) fine particles of vapor-phase process silica, (2) ion exchange water and (3) SHAROLL DC-902P, subjecting the resultant mixture to a dispersing operation using an ultrasonic dispersing machine (made by SMT Co., Ltd.), and then heating the resultant dispersion liquid at 45° C. and keeping it for 20 hours, and further adding (4) boric acid, (5) a polyvinyl alcohol solution and (6) water-soluble polyaluminum chloride to the dispersion liquid at 30° C.

Composition of Coating Solution B1 for Ink-Receiving Layer

| | | |
|---|---|---|
| (1) | Fine particles of vapor-phase process silica (pigment) | 10.0 parts |
| | (AEROSIL 300SV, manufactured by Nippon Aerosil) | |
| (2) | Ion exchange water | 62.8 parts |
| (3) | SHAROLL DC-902P (51.5% aqueous solution) | 0.87 parts |
| | (dispersant, manufactured by | |
| | Dai-ichi Kogyo Seiyaku Co., Ltd.) | |
| (4) | Boric acid (crosslinking agent) | 0.44 pars |
| (5) | Polyvinyl alcohol (binder) solution | 34.9 parts |
| (6) | Water-soluble polyaluminum chloride (ALFINE 83, | 1.4 parts |
| | manufactured by TAIMEI CHEMICALS CO., | |
| | LTD.; water-soluble aluminum compound) | |

The composition of the polyvinyl alcohol solution was as follows.

Composition of Polyvinyl Alcohol Solution

| | |
|---|---|
| PVA-117 manufactured by Kuraray Co., Ltd. | 2.43 parts |
| (saponification degree: 99%, polymerization degree: 1,700) | |
| Polyoxyethylene lauryl ether (surfactant) (EMULGEN 109P, | 0.03 parts |
| 10% aqueous solution, HLB value: | |
| 13.6, manufactured by Kao Corporation) | |
| Diethylene glycol monobutyl ether (BUTYCENOL 20P, | 0.74 parts |
| manufactured by KYOWA HAKKO CHEMICAL CO., LTD.) | |
| Ion exchange water | 31.0 parts |

Making of Inkjet Recording Sheet

The front side of the waterproof substrate was subjected to corona discharge treatment. The front side was coated with the coating solution A1 for an ink-receiving layer and the coating solution B1 for an ink-receiving layer by simultaneous multilayer superposition coating using a slide bead coater in such a manner that the coating solution A1 formed an upper layer (the layer on the far side from the waterproof substrate; a first layer) in a dry coating amount of 7 g/m² and the coating solution B1 formed a lower layer (the layer on the near side to the waterproof substrate; a second layer) in a dry coating amount of 20 g/m².

The coating films thus obtained were cooled for 1 minute at 5° C., and then dried at 40° C., thereby forming ink-receiving layers.

Thus, an inkjet recording sheet was obtained.

Evaluations

The following evaluations were made on the thus-obtained inkjet recording sheet. Evaluation results are shown in Table 1.

### Hue Change

Printing in solid gray color was performed on the side of the inkjet recording sheet at which the ink-receiving layer is formed using an A820 printer manufactured by SEIKO EPSON CORPORATION. The color tone of the image data was adjusted to provide a gray density of about 1.7.

The hue in gray areas immediately after printing (within 3 minutes after printing) and after 24 hours had elapsed since printing, respectively, was measured, and the difference between the hue just after printing and the hue after 24 hours had elapsed since printing was defined as color difference (ΔE).

Herein, the measurement of hue was performed by L*a*b* measurements using a spectrophotometer (SPECTROLINO, manufactured by GretagMacbeth AG) under the conditions of light source F8 and a viewing angle of 2 degrees.

From the color difference (ΔE) thus obtained, hue change evaluation was made in accordance with the following criteria.

Evaluation Criteria

| | |
|---|---|
| A . . . ΔE < 2 | Hue change can hardly be perceived. |
| B . . . 2 ≦ ΔE < 4 | Hue change is perceivable, but not very noticeable. |
| C . . . 4 ≦ ΔE < 7 | Hue change is rather noticeable. |
| D . . . 7 ≦ ΔE | Hue change is significant and problematic. |

Unevenness Resulting from Overlap

Printing in solid gray color was performed on the side of the inkjet recording sheet at which the ink-receiving layer is formed using an A820 printer manufactured by SEIKO EPSON CORPORATION. The color tone of the image data was adjusted to provide a gray density of about 1.7.

The gray area was partially covered with a glass plate immediately after printing (within 3 minutes after printing), and left standing for 24 hours. After 24 hours, the hue in the glass plate-covered part of the gray area and the hue in the remainder of the gray area on which no glass plate had been placed were each measured by means of a spectrophotometer, and the difference between these hues was defined as color difference (ΔE). Measurement of these hues was made under the same conditions as the hue change evaluation.

From the color difference (ΔE) thus obtained, unevenness resulting from overlap (overlap mark) was evaluated in accordance with the following criteria.

Evaluation Criteria

| | |
|---|---|
| A . . . ΔE < 5 | Unevenness is hardly noticeable. |
| B . . . 5 ≦ ΔE < 9 | Unevenness is perceivable, but presents |
| | no serious problem. |
| C . . . 9 ≦ ΔE < 13 | Unevenness is rather noticeable. |
| D . . . 13 ≦ ΔE | Unevenness is significant and problematic. |

Bleeding in High Humidity Environment

In an environment of 23° C. and 50% RH, a rectangular shape measuring 3 cm per side, in which a checkered pattern (length of each side of a square: 0.28 mm) was formed of juxtaposed magenta and black lines, was printed on the side of the inkjet recording sheet at which the ink-receiving layer is formed using an MP970 printer manufactured by Canon Inc. Immediately after the printing, the printed inkjet recording sheet was transferred to an environment of 23° C. and 90% RH, and left standing for 7 days. After 7 days had elapsed, the inkjet recording sheet was fully dried in an environment of 23° C. and 50% RH, and the degree of bleeding was observed visually. Bleeding in high humidity surroundings was evaluated in accordance with the following criteria.

Evaluation Criteria

A . . . No bleeding is recognizable.

B . . . Bleeding is hardly noticeable.

C . . . Some bleeding is noticed, but is within acceptable limits.

D . . . Bleeding is significant and problematic.

Waterproofing

In an environment of 23° C. and 50% RH, solid images having a rectangular shape measuring 2 cm per side were printed in yellow, magenta, cyan, red, green, blue and black, respectively, on the side of the inkjet recording sheet at which the ink-receiving layer is formed using an MP970 printer manufactured by Canon Inc. After the printing, the inkjet recording sheet was dried for 24 hours under the 23° C. and 50% RH conditions, and then immersed in ion exchange water for 10 minutes. Thereafter, the degree of bleeding of the dyes was observed visually, and the waterproofing was evaluated in accordance with the following criteria.

Evaluation Criteria

A . . . No bleeding is recognizable.

B . . . Bleeding is hardly noticeable.

C . . . Some bleeding is noticed, but is within acceptable limits.

D . . . Bleeding is significant and problematic.

Bronzing

In an environment of 23° C. and 70% RH, solid images in blue and cyan were printed on the side of the inkjet recording sheet at which the ink-receiving layer is formed using an A820 printer manufactured by SEIKO EPSON CORPORATION. The degree of bronzy gloss was observed visually, and the bronzing was evaluated in accordance with the following criteria.

Evaluation Criteria

A . . . No bronzy gloss develops.

B . . . Bronzy gloss develops to a slight extent, but is inconspicuous.

C . . . Bronzy gloss is clearly recognized.

Film Cracking

During the preparation of the inkjet recording sheet, the degree of film cracking occurring at the ink-receiving layer surface during the coating and drying operations was observed visually and evaluated in accordance with the following criteria.

Evaluation Criteria

A . . . No coat cracking occurs.

B . . . Coat cracking occurs very slightly, but is hardly perceivable.

C . . . Occurrence of coat cracking is recognizable, but is within a practically acceptable level.

D . . . Incidence of coat cracking is high, and is beyond a practically acceptable level.

E . . . Incidence of coat cracking is very high, and is problematic.

### Example 2

An inkjet recording sheet was made in the same manner as in Example 1, except that both PVA-117 in the coating solution A1 for ink-receiving layer (upper layer) and PVA-117 in the coating solution B1 for ink-receiving layer (lower layer) were replaced with PVA-145 manufactured by Kuraray Co., Ltd. (saponification degree: 99%, polymerization degree: 4,500).

Evaluations were made on the thus-obtained inkjet recording sheet by the same methods as in Example 1. Evaluation results obtained are shown in Table 1.

### Example 3

An inkjet recording sheet was made in the same manner as in Example 1, except that PVA-117 in the coating solution B1 for ink-receiving layer (lower layer) was replaced with PVA-145 manufactured by Kuraray Co., Ltd. (saponification degree: 99%, polymerization degree: 4,500).

Evaluations were made on the thus-obtained inkjet recording sheet by the same methods as in Example 1. Evaluation results obtained are shown in Table 1.

### Example 4

An inkjet recording sheet was made in the same manner as in Example 1, except that both PVA-117 in the coating solution A1 for ink-receiving layer (upper layer) and PVA-117 in the coating solution B1 for ink-receiving layer (lower layer) were replaced with a combination of JM33 manufactured by JAPAN VAM & POVAL CO., LTD. (saponification degree: 95%, polymerization degree: 3,300) and PVA-235 manufactured by Kuraray Co., Ltd. (saponification degree: 88%, polymerization degree: 3,500) in a mass ratio (JM33:PVA235) of 85:15.

Evaluations were made on the thus-obtained inkjet recording sheet by the same methods as in Example 1. Evaluation results obtained are shown in Table 1.

### Comparative Example 1

An inkjet recording sheet was made in the same manner as in Example 1, except that PVA-117 in the coating solution Al for ink-receiving layer (upper layer) was replaced with PVA-235 manufactured by Kuraray Co., Ltd. (saponification degree: 88%, polymerization degree: 3,500) and only the coating solution Al for ink-receiving layer was applied in a dry coating amount of 27 g/m² in the process of making the inkjet recording sheet. The coating solution B1 for ink-receiving layer (lower layer) was not applied.

Evaluations were made on the thus-obtained inkjet recording sheet by the same methods as in Example 1. Evaluation results obtained are shown in Table 1.

### Comparative Example 2

An inkjet recording sheet was made in the same manner as in Example 1, except that PVA-117 in the coating solution B1 for ink-receiving layer (lower layer) was replaced with PVA-235 manufactured by Kuraray Co., Ltd. (saponification degree: 88%, polymerization degree: 3,500) and only the coating solution B1 for ink-receiving layer was applied in a dry coating amount of 27 g/m² in the process of making the inkjet recording sheet. In other words, the coating solution A1 for ink-receiving layer (upper layer) was not applied.

Evaluations were made on the thus-obtained inkjet recording sheet by the same methods as in Example 1. Evaluation results obtained are shown in Table 1.

### Comparative Example 3

An inkjet recording sheet was made in the same manner as in Comparative Example 2, except that the coating solution B1 for ink-receiving layer was replaced with a coating solution A2 prepared in the following manner.

Evaluations were made on the thus-obtained inkjet recording sheet by the same methods as in Example 1. Evaluation results obtained are shown in Table 1.

Preparation of Coating Solution A2 for Ink-Receiving Layer

A coating solution A2 for formation of an ink-receiving layer, having the following composition was prepared by mixing (1) fine particles of vapor-phase process silica, (2) ion exchange water, (3) SHAROLL DC-902P and (4) ZA-30, subjecting the resultant mixture to a dispersing operation using an ultrasonic dispersing machine (made by SMT Co., Ltd.), and then heating the resultant dispersion liquid at 45° C. and keeping it for 20 hours, and further adding (5) boric acid, (6) a polyvinyl alcohol solution and (7) a water-soluble polyaluminum chloride to the dispersion liquid at 30° C.

Composition of Coating Solution A2 for Ink-Receiving Layer

| | | |
|---|---|---|
| (1) | Fine particles of vapor-phase process silica (pigment) | 10.0 parts |
| | (AEROSIL 300SV, manufactured by Nippon Aerosil) | |
| (2) | Ion exchange water | 62.8 parts |
| (3) | SHAROLL DC-902P (51.5% aqueous solution) | 0.87 parts |
| | (dispersant, manufactured by Dai-ichi | |
| | Kogyo Seiyaku Co., Ltd.) | |
| (4) | ZA-30 (zirconyl acetate, manufactured by DAIICHI | 0.54 parts |
| | KIGENSO KAGAKU KOGYO CO., | |
| | LTD.; water-soluble zirconium compound) | |
| (5) | Boric acid (crosslinking agent) | 0.44 pars |
| (6) | Polyvinyl alcohol (binder) solution | 34.9 parts |
| (7) | Water-soluble polyaluminum chloride | 1.4 parts |
| | (ALFINE 83, manufactured by TAIMEI | |
| | CHEMICALS CO., LTD.; | |
| | water-soluble aluminum compound) | |

The composition of the polyvinyl alcohol solution was as follows.

Composition of Polyvinyl Alcohol Solution

| | |
|---|---|
| PVA-235 manufactured by Kuraray Co., Ltd. (saponification | 2.43 parts |
| degree: 88%, polymerization degree: 3,500) | |
| Polyoxyethylene lauryl ether (surfactant) (EMULGEN 109P, | 0.03 parts |
| 10% aqueous solution, HLB value: 13.6, | |
| manufactured by Kao Corporation) | |
| Diethylene glycol monobutyl ether (BUTYCENOL 20P, | 0.74 parts |
| manufactured by KYOWA HAKKO CHEMICAL CO., LTD.) | |
| Ion exchange water | 31.0 parts |

### Comparative Example 4

An inkjet recording sheet was made in the same manner as in Comparative Example 3, except that PVA-235 in the coating solution A2 for ink-receiving layer was replaced with PVA-117 manufactured by Kuraray Co., Ltd. (saponification degree: 99%, polymerization degree: 1,700).

Evaluations were made on the thus-obtained inkjet recording sheet by the same methods as in Example 1. Evaluation results obtained are shown in Table 1.

### Comparative Example 5

An inkjet recording sheet was made in the same manner as in Example 1, except that both PVA-117 in the coating solution A1 for ink-receiving layer (upper layer) and PVA-117 in the coating solution B1 for ink-receiving layer (lower layer) were replaced with PVA-235 manufactured by Kuraray Co., Ltd. (saponification degree: 88%, polymerization degree: 3,500).

Evaluations were made on the thus-obtained inkjet recording sheet by the same methods as in Example 1. Evaluation results obtained are shown in Table 1.

### Comparative Example 6

An inkjet recording sheet was made in the same manner as in Example 1, except that both PVA-117 in the coating solution A1 for ink-receiving layer (upper layer) and PVA-117 in the coating solution B1 for ink-receiving layer (lower layer) were replaced with a combination of JM33 manufactured by JAPAN VAM & POVAL CO., LTD. (saponification degree: 95%, polymerization degree: 3,300) and PVA-235 manufactured by Kuraray Co., Ltd. (saponification degree: 88%, polymerization degree: 3,500) in a mass ratio (JM33/PVE235) of 75:25.

Evaluations were made on the thus-obtained inkjet recording sheet by the same methods as in Example 1. Evaluation results obtained are shown in Table 1.

TABLE 1

| | | | | | | Compar- | Compar- | Compar- | Compar- | Compar- | Compar- |
|---|---|---|---|---|---|---|---|---|---|---|---|
| | | | | | | ative | ative | ative | ative | ative | ative |
| | | Example 1 | Example 2 | Example 3 | Example 4 | Example 1 | Example 2 | Example 3 | Example 4 | Example 5 | Example 6 |
| Upper | Polyvalent | Zr | Zr | Zr | Zr | | | | | Zr | Zr |
| Layer | metal | | | | | | | | | | |
| | compound (*1) | | | | | | | | | | |
| | Binder | PVA-117 | PVS-145 | PVA-117 | JM33 | | | | | PVA-235 | JM33 |
| | (Saponification | (99%/ | (99%/ | (99%/ | (95%/3,300) | | | | | (88%/ | (95%/3,300) |
| | degree of PVA/ | 1,700) | 4,500) | 1,700) | 85 mass % | | | | | 3,500) | 75 mass % |
| | polymerization | | | | PVA-235 | | | | | | PVA-235 |
| | degree of PVA) | | | | (88%/3,500) | | | | | | (88%/3,500) |
| | | | | | 15 mass % | | | | | | 25 mass % |
| Lower | Polyvalent | Al | Al | Al | Al | Zr | Al | Zr, Al | Zr, Al | Al | Al |
| Layer | metal | | | | | | | | | | |
| | compound (*1) | | | | | | | | | | |
| | Binder | PVA-117 | PVS-145 | PVA-145 | JM33 | PVA-235 | PVA-235 | PVA-235 | PVA-117 | PVA-235 | JM33 |
| | (Saponification | (99%/ | (99%/ | (99%/ | (95%/3,300) | (88%/ | (88%/ | (88%/ | (99%/ | (88%/ | (95%/3,300) |
| | degree of PVA/ | 1,700) | 4,500) | 4,500) | 85 mass % | 3,500) | 3,500) | 3,500) | 1,700) | 3,500) | 75 mass % |
| | polymerization | | | | PVA-235 | | | | | | PVA-235 |
| | degree of PVA) | | | | (88%/3,500) | | | | | | (88%/3,500) |
| | | | | | 15 mass % | | | | | | 25 mass % |

| | | | | | | | | | | |
|---|---|---|---|---|---|---|---|---|---|---|
| Hue change | A | B | A | B | D | D | C | A | D | C |
| Unevenness resulting | A | B | A | B | D | D | D | A | D | D |
| from overlap | | | | | | | | | | |
| Bleeding in high | A | A | A | A | A | C | A | A | A | A |
| humidity | | | | | | | | | | |
| Waterproofness | A | A | A | A | C | A | A | A | A | A |
| Bronzing | A | A | A | A | A | C | C | C | A | A |
| Coat Cracking | C | B | A | B | | | | | | |

(*1) In the “Polyvalent metal compound” column of Table 1, Zr represents a water-soluble zirconium compound and Al represents a water-soluble aluminum compound.

In Examples 1 to 4, as shown in Table 1, bleeding and bronzing were prevented from occurring in high-humidity environments, and besides, hue change and overlap mark were inhibited from developing and excellent waterproofing was achieved.

Although slight coat cracking on an acceptable level occurred in Example 1, the coat cracking was significantly improved in Examples 2 to 4. In Example 3 in particular, the alleviation of coat cracking was outstanding.

What is claimed is:

1. An inkjet recording material, comprising:
a waterproof substrate; and
at least two ink-receiving layers that are provided on the waterproof substrate and include a first ink-receiving layer and a second ink-receiving layer,
wherein the second ink-receiving layer is located at a position nearer to the waterproof substrate than the first ink-receiving layer,
the first ink-receiving layer comprises a pigment, a water-soluble zirconium compound, and a binder,
the second ink-receiving layer comprises a pigment, a binder, and a water-soluble aluminum compound, the amount of the water-soluble aluminum compound being larger than that of a water-soluble aluminum compound included in the first ink-receiving layer, and
at least 80% by mass of the binders included in the at least two ink-receiving layers comprises a polyvinyl alcohol having a saponification degree of 95% or higher.

2. The inkjet recording material according to claim 1, wherein at least 85% by mass of the binders included in the at least two ink-receiving layers comprises a polyvinyl alcohol having a saponification degree of 95% or higher.

3. The inkjet recording material according to claim 1, wherein the mass ratio of the water-soluble aluminum compound included in the first ink-receiving layer to the water-soluble aluminum compound included in the second ink-receiving layer is from 0 to less than 1.0.

4. The inkjet recording material according to claim 1, wherein the amount of the water-soluble zirconium compound included in the first ink-receiving layer is from 0.5 to 15% by mass with respect to the mass of the pigment in the first ink-receiving layer.

5. The inkjet recording material according to claim 1, wherein the amount of the water-soluble aluminum compound included in the second ink-receiving layer is from 0.5 to 15% by mass with respect to the mass of the pigment in the second ink-receiving layer.

6. The inkjet recording material according to claim 1, wherein the binder included in the first ink-receiving layer comprises a polyvinyl alcohol having a polymerization degree of 2,000 or less, and the binder included in the second ink-receiving layer comprises a polyvinyl alcohol having a polymerization degree of 2,000 or more.

7. The inkjet recording material according to claim 6, wherein the binder included in the first ink-receiving layer comprises a polyvinyl alcohol having a polymerization degree of 1,900 or less, and the binder included in the second ink-receiving layer comprises a polyvinyl alcohol having a polymerization degree of 3,000 or more.

8. The inkjet recording material according to claim 1, wherein the pigment included in the first ink-receiving layer and the pigment included in the second ink-receiving layer comprise silica particles.

9. The inkjet recording material according to claim 8, wherein the silica particles comprise vapor-phase silica.

10. The inkjet recording material according to claim 1, wherein the total amount of the pigments included in the at least two ink-receiving layers is 60% by mass or more with respect to the total solid content of the at least two ink-receiving layers.

11. The inkjet recording material according to claim 1, wherein a dry coating amount of the first ink-receiving layer is 8 g/m² or more.

12. The inkjet recording material according to claim 1, wherein a dry coating amount of the second ink-receiving layer is 12 g/m² or more.

13. A method for manufacturing an inkjet recording material, comprising:
applying coating solution B comprising a binder, a pigment, and a water-soluble aluminum compound and a coating solution A comprising a binder, a pigment, and a water-soluble zirconium compound on a waterproof substrate such that the coating solution B and the coating solution A are applied on the waterproof substrate in this order,
wherein the amount of the water-soluble aluminum compound included in the coating solution B is larger than that of a water-soluble aluminum compound included in the coating solution A, and
wherein at least 80% by mass of the binders included in the coating solutions A and B for forming ink-receiving layers comprises a polyvinyl alcohol having a saponification degree of 95% or more.

14. The method for manufacturing an inkjet recording material according to claim 13, wherein the mass ratio of the water-soluble aluminum compound included in the coating solution A to the water-soluble aluminum compound included in the coating solution B is from 0 to less than 1.0.

15. The method for manufacturing an inkjet recording material according to claim 13, wherein the binder included in the coating solution A comprises a polyvinyl alcohol having a polymerization degree of 2,000 or less, and the binder included in the coating solution B comprises a polyvinyl alcohol having a polymerization degree of 2,000 or more.

16. The method for manufacturing an inkjet recording material according to claim 13, wherein the amount of the water-soluble zirconium compound included in the coating solution A is from 0.5 to 15% by mass with respect to the mass of the pigment in the coating solution A.

17. The method for manufacturing an inkjet recording material according to claim 13, wherein the amount of the water-soluble aluminum compound included in the coating solution B is from 0.5 to 15% by mass with respect to the mass of the pigment in the coating solution B.

18. The method for manufacturing an inkjet recording material according to claim 13, wherein a dry coating amount of the coating solution A is 8 g/m² or more.

19. The method for manufacturing an inkjet recording material according to claim 13, wherein a dry coating amount of the coating solution B is 12 g/m² or more.
